(19) United States
(12) Patent Application Publication
(10) Pub. No.: US 2024/0263878 A1
(43) Pub. Date: Aug. 8, 2024

(54) MULTI-PASS DRYING PROCESS FOR A WET SUBSTANCE

(71) Applicant: SINGNERGY CORPORATION PTE. LTD., Singapore (SG)

(72) Inventor: Keng Tai CHUA, Singapore (SG)

(73) Assignee: SINGNERGY CORPORATION PTE. LTD., Singapore (SG)

(21) Appl. No.: 18/569,674

(22) PCT Filed: Jul. 2, 2021
(86) PCT No.: PCT/SG2021/050388

§ 371 Date: Dec. 13, 2023

(51) Int. Cl. F26B 17/02; F26B 3/20; F26B 17/28

(52) U.S. Cl. CPC F26B 17/026; F26B 3/20; F26B 17/284

(57) ABSTRACT

A multi-pass drying process for a wet substance is disclosed. Said multi-pass drying process comprises the steps of passing the wet substance through at least two different drying stages to produce a semi-dried product between the drying stages, with stirring and ventilating the semi-dried product between each drying stage, wherein the wet substance or the semi-dried product is subjected to compression while being heated in at least one of the drying stages. The multi-pass process ensures a high degree of control over the final dried product and allows certain flexibility to ensure higher throughput. Such a multi-pass drying process is suitable when seeking to obtain food products such as dried food premix or food ingredients, where the final dried product needs to be of high dryness to attain longer shelf life, high nutritional content, strong aroma and to be superior in other organoleptic properties.

### FIELD

The present invention relates to a multi-pass drying process for a wet substance. While the present invention will be described with respect to its application for side streams from food or beverage production lines, it is to be appreciated that the present invention is not restricted to this application, and other applications are also envisaged.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Conventional dryer technology available in the market include but are not limited to drum dryers, belt dryers, disk dryers, paddle dryers, fluid bed dryer, tray dryer, rotary dryer, screw conveyor dryer or any dryer which does not apply compression while heating. The Applicant has however developed and produced different drying apparatuses to dry wet substance while being compressed and heated at the same time in a single pass through their drying apparatus. The use of these drying apparatuses can lead to reduced drying times for wet substances being dried within the apparatus when compared with conventional drying apparatus. The Applicant therefore refers to the drying apparatus that they have developed as their ‘Super Quick (SQ) drying technology’.

The SQ drying technology can dry various types of wet input substances which can vary in terms of moisture content, nature and characteristics. The drying process required for different input substances should therefore ideally be optimised for the substance to obtain optimal parameters and produce dried products as per end requirements.

Certain wet substances are obtained as side streams from food or beverage production lines. Examples of such wet input substances include spent grains, Okara (soy pulp) from soy processing plants, fruit pomace (grape, carrot, apple, etc.), fish waste, etc. These side stream wet substances need to be processed within the holding time restrictions from the food or beverage production lines. Holding time is defined as the moment it exits the production line to the time it is fed into the dryer. This requires the substance to be dried over a shorter period, while at the same time ensuring high dryness to thereby attain longer shelf life, high nutritional content, strong aroma, as well as being superior in other organoleptic properties.

It would therefore be advantageous to be able to optimise the drying process for substances including the above described side stream wet substances from food or beverage production lines to satisfy the end requirements such as the organoleptic properties of such substances when dried.

### SUMMARY

According to an aspect of the present disclosure, there is provided a multi-pass drying process for a wet substance comprising:
a) passing the wet substance through at least two different drying stages to produce a semi-dried product between the drying stages, and
b) stirring and ventilating the semi-dried product between each drying stage;
   wherein the wet substance or the semi-dried product is subjected to both compression and heating in at least one of the drying stages.

In some embodiments, at least one of the drying stages is conducted within a drying assembly comprising at least one rotating drum, and at least one belt for supporting and compressing the wet substance or the semi-dried product as the or each belt travels around an external surface of the or each drum.

In some embodiments, the exterior surface of the or each rotating drum is heated by a heated fluid contained within the drum.

In some embodiments, the or each belt is formed from a metal material, and is heated using heat induction within the drying apparatus.

In some embodiments, the drum is made of metal when a single said belt is used.

In some embodiments, two said belts are provided, the wet substance or the semi-dried product being sandwiched between the belts.

In some embodiments, at least one of the drying stages is conducted by a conventional drying apparatus subjecting the wet substance to heat without compression.

In some embodiments, the conventional drying apparatus provides the first drying stage.

In some embodiments, each of the drying stages subject the wet substance or the semi-dried product to compression while being heated.

In some embodiments, the stirring and ventilation of the semi-dried product between each drying stage is achieved naturally during the handling of the semi-dried product while being transferred between each drying stage.

In some embodiments, the stirring and ventilation of the semi-dried product between each drying stage is achieved using an assistive device for performing a stirring and ventilating action on the semi-dried product.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present invention,

FIG. 1 is a diagram illustrating a two pass drying process according to the present disclosure;

FIG. 2 is a diagram illustrating a multi pass drying process according to the present disclosure; and

FIG. 3 is a flow chart of the steps involved in a multi pass drying process according to the present disclosure.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

The Applicant has developed and produced drying apparatuses that differ from conventional dryers to conduct drying by both compressing and heating substances within the apparatus at the same time. The Applicant uses the term ‘SQ Drying Technology’ to refer to these drying apparatuses. One such drying apparatus utilises a belt for supporting the wet substance passing through the apparatus, and a rotating drum about which the belt can travel. The travel of the belt around the drum results in the compression of wet substances supported on the belt directly against the exterior circumferential surface of the drum. The drum itself is heated by thermal oil within the drum, and the wet substance is heated though the conduction of heat from the outer drum surface.

U.S. Pat. No. 10,571,191 discloses another apparatus for drying a substance developed by the present Applicant, hereinafter referred to as the ‘Applicant's U.S. patent’. Details of the Applicant's U.S. patent are incorporated herein by reference. This apparatus most broadly comprises at least one non-metal drum rotatable about a central axis; and a first metal belt having a first and a second side, the first side of the first belt adapted to receive the substance. One or more heating devices in the form of heat induction elements are arranged proximate to and about a portion of a surface of the drum. During operation of the apparatus, the first belt urges via its first side, the substance towards a portion of an exterior circumferential surface of the drum, while the one or more heat induction elements induce heat in the first belt to heat the substance to remove fluids from the substance, while do not inducing heat in the non-metal drum.

The applicant's U.S. patent further discloses alternative embodiments of the drying apparatus. At least one heat induction element may be arranged within the drum, proximate to and about a portion of an interior surface of the drum. Alternatively, or in addition, at least one heat induction element may be arranged proximate to and about the portion of the exterior surface of the drum. During operation, the substance and the first belt may be driven between a portion of the exterior circumferential surface of the drum and the heat induction element. Other features of these embodiments may include a second belt which may also be made from metal. The second belt may have a first and second side, where in operation, the substance is sandwiched between the second side of the first belt and the first side of the second belt. The second belt may urge via its first side, the substance and the first belt towards the portion of the exterior circumferential surface of the drum. Heat may also be induced in the second belt by the one or more heat induction elements. Furthermore, a plurality of drums may be provided in another embodiment, with the second belt also acting to urge via its first side, the substance and the first belt towards the portion of an exterior circumferential surface of at least one of the drums. The drum may alternatively be made of metal in a single belt configuration of the apparatus.

When using the above described drying apparatuses using this SQ Drying Technology, which will be referred to as ‘SQ dryers’, the total drying time is typically kept within 10-18 minutes to dry the wet substance from 60%-80% moisture content to a final dried product of 2%-15% moisture content in a single pass through the SQ dryer. The high-quality dried products obtained using the SQ Drying Technology is therefore high in nutrients, has strong aroma and is optimal in other organoleptic properties.

In further trials and tests on the SQ dryers, it has been found that using a multi-pass drying operation, where the substance to be dried is passed through an SQ dryer more than one time, can give rise to more flexible and easy handling of the substance during the feeding and drying process.

There are certain wet substances such as side-streams from food and beverage manufacturers which restricts the total holding time from the point it exits the production line to the time it is fed into the dryer, such that it falls within a stipulated time frame. This is due to the high moisture content in the wet food substance which will lead to the multiplication of microorganisms should the time requirements are not met. It has been found that using a two-pass drying process incorporating a stirring and ventilating stage between each pass can achieve optimal dried products free from pathogens and mycotoxins, while keeping the total drying time short and comparable to a single-pass drying operation. The stirring and ventilating stage after the first pass drying process, allows the semi-dried product to further reduce moisture. The stirring process ensures a higher degree of uniformity of the semi-dried product fed into the second pass drying process. Therefore, the final dried output will display products of uniform colour and consistency while achieving extremely high dryness.

It is envisaged that more than two passes may be required to meet specific end requirements. There may also be situations where a multi-pass process may utilize a single SQ dryer implemented in batches, or several SQ dryers in continuous operation. It is also envisaged that at least one of the drying passes be through a conventional dryer, which include but are not limited to drum dryers, belt dryers, disk dryers and paddle dryers.

It has been found that different drying approaches are required for different types of wet input substances. Many input substances only require a single-pass drying operation, and the most optimal heating temperature, heating duration and compression level can be identified for these substances on a single-pass operation, the operation being considered complete once the final dried product drops out into the output collection container. There are however input substances where the implementation of a multi-pass drying process is preferred or required. The first pass targets achieving a high throughput to thereby obtain a semi-dried product. The semi-dried product will then be collected and transferred to thereby undergo a second pass drying process. Moisture is further lost through stirring and ventilating during the transfer phase to result in a more homogeneous input to the next SQ dryer. The stirring and ventilating process could happen naturally during the transfer of the semi-dried product from the first SQ dryer to the next SQ dryer, or it could be assisted using a specialized equipment or device to stir and/or distribute the semi-dried product into the next SQ dryer. These assistive devices include but are not restricted to an enclosed conveyer with a suction fan, a distributor with a stirrer using a shaft and spoke design, or a suction fan which creates a forced draft across the semi-dried product. The drying parameters can be same or different for each of the drying passes.

A typical single-pass SQ drying process to dry wet substances from 70% mc to less than 10% mc typically requires approximately 10-16 minutes. When a two-pass SQ drying process is implemented, each pass will require approximately 5-9 minutes to obtain dried products containing 2%-8% mc.

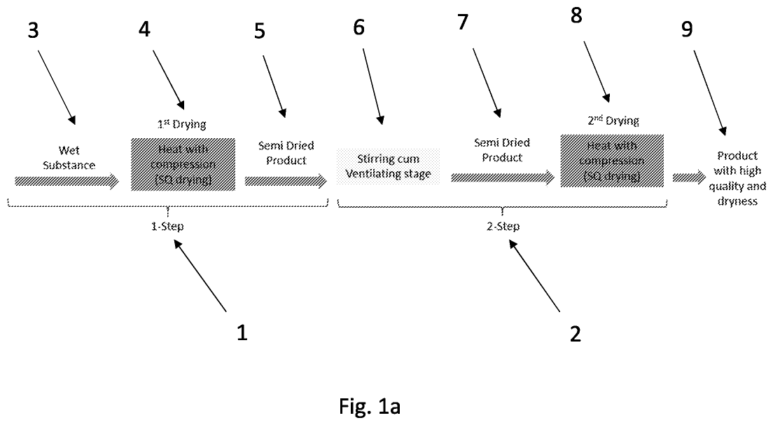

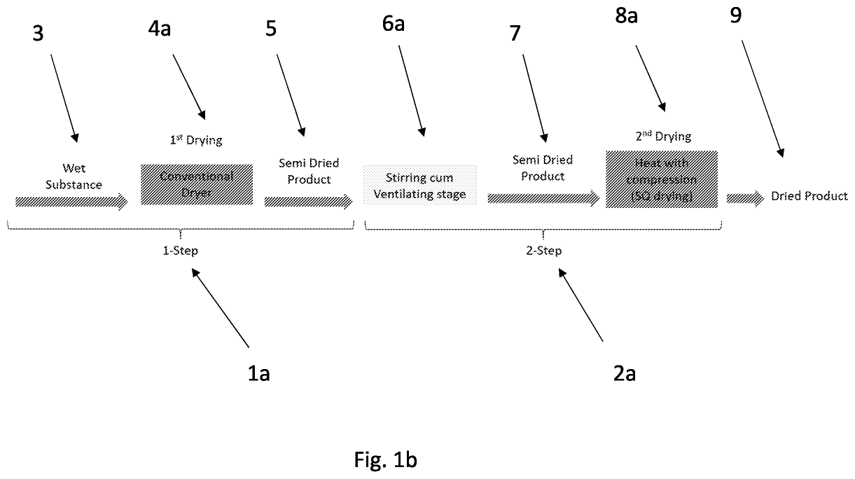

A typical two-pass operation is schematically shown in the diagram of FIG. 1a. The two-pass operation has two steps (1), (2), with the first step comprising feeding a wet substance (3) into an SQ dryer to thereby undergo heating with compression within the SQ dryer (4), before being discharged as a semi-dried product (5). In the second step, the semi-dried product (5) undergoes a stirring cum ventilating stage (6), with the now stirred and ventilated semi-dried product (7) fed into the same or another SQ dryer to undergo further heating with compression (8), before the final dried product (9) of high quality and dryness is finally delivered from that SQ dryer. It is also envisaged that a conventional dryer be employed for the drying of the wet substances during the first pass to obtain a semi-dried product to be fed into the SQ dryer for the second pass drying process. FIG. 1b schematically shows an alternative two-pass operation where a conventional dryer is used in place of an SQ dryer in the first step (1a). The wet substance (3) is fed into the conventional dryer (4a) to undergo heating without compression. The semi-dried product (5) delivered from the conventional dryer is then fed into the second step (2a) which remains the same as that shown in FIG. 1a, with the semi-dried product (5) undergoing a stirring cum ventilating stage (6a) before being fed into and undergoing heating and compression within an SQ dryer (8a). The final dried product (9) is then delivered from the SQ dryer.

This configuration is especially suitable for wet substances which need to be processed within the holding time restrictions from the food or beverage production lines. Examples of such wet input substances are spent grains, Okara (soy pulp) from soy processing plants, fruit pomace (grape, carrot, apple, etc.), fish waste, etc. The two-pass process ensures a high degree of control over the final dried product and allows certain flexibility to ensure higher throughput. Such a two-pass process is suitable when seeking to obtain food products such as dried food premix or food ingredients, where the final dried product needs to be of high dryness to attain longer shelf life, high nutritional content, strong aroma and to be superior in other organoleptic properties.

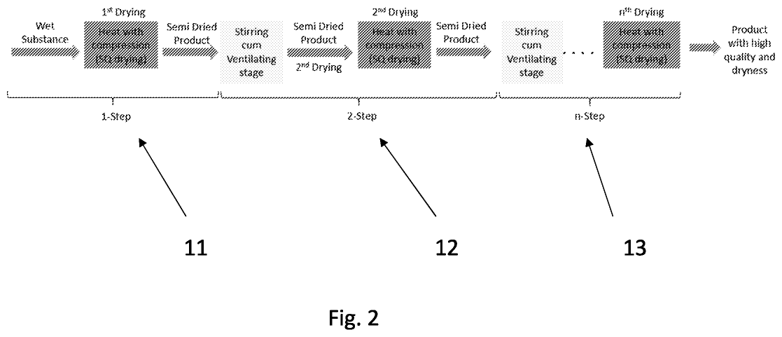

There will also be situations where we may be required to go more than two drying passes in a multi-pass operation as schematically shown in the diagram of FIG. 2. The multi-pass operation has a first and second step (11), (12) and multiple further steps (13) as required. The first and second steps (11), (12) in the multi-pass operation will have the same stages as the two steps of the two-pass operation as shown in FIG. 1. Each subsequent step (13) will also include a stirring cum ventilating stage and heat with compression stage in an SQ dryer as in the second step (12).

Such a multi-pass operation may utilize a single SQ dryer implemented in batches, or several SQ dryers in continuous operation. It is also envisaged that a conventional dryer may be employed for the drying of the wet substances during the first pass to obtain a semi-dried product to be fed into the SQ dryer for the second pass drying process as previously described. Similarly, the transfer phase from the first pass to the second pass involving stirring and ventilating, can occur naturally or via assistive devices. The dried products obtained through this route will however be lower in quality in comparison to the dried products which utilize only SQ drying. This is primarily due to the extended amount of drying time used during the conventional drying stage which will strip away nutrients, aroma and other organoleptic properties.

There are three basic drying configurations of the multi-pass drying process.

Firstly, the multi-pass drying process can be accomplished with a single SQ dryer. Once the wet substance is received, the parameter settings on the SQ dryer will be set. Parameters such as the heating temperature, heating time and compression levels will be selected according to substance characteristics. The first pass drying will result in a semi-dried product within 5-12 minutes, which will then undergo stirring and ventilating, either naturally or through assistive devices, to further reduce moisture content before it is once again fed into the same SQ dryer for the second pass drying. This process may be repeated to obtain a final dried product of high quality and high dryness of between 2%-8% mc. As there is only one SQ dryer, each pass will be performed in batches incorporating the stirring and ventilation process between each pass.

Secondly, the multi-pass drying process can be accomplished with at least two SQ dryers. Once the wet substance is received, the parameter settings such as heating temperature, heating time and compression levels on the first SQ dryer will be set. The wet substance will then be fed into the first SQ dryer to result in a semi-dried product within 5-12 minutes, which will then undergo stirring and ventilating, either naturally or through assistive devices, to further reduce moisture content. If there is a need to change the parameters for the second pass drying, it will be set before the semi-dried product is fed into the second SQ dryer for the second pass drying. Typically, two SQ dryers will be sufficient for most of the applications. However, if a third or more pass is required, the process sequence will be repeated on the subsequent SQ dryers until it results in the final high quality, high dryness product, incorporating the stirring and ventilation process between each pass. With multiple SQ dryers available, the drying process can be operated continuously.

Thirdly, the multi-pass drying process can be accomplished with a conventional dryer followed by using at least one SQ dryer for the subsequent drying pass/passes. When the wet substance is received, it will undergo the first pass drying using a conventional dryer to obtain the semi-dried product. Similarly, the semi-dried product will undergo stirring and ventilating, either naturally or through assistive devices, to further reduce moisture content. The parameters such as heating temperature, heating time and compression levels will then be set on the first SQ dryer for the second pass drying.

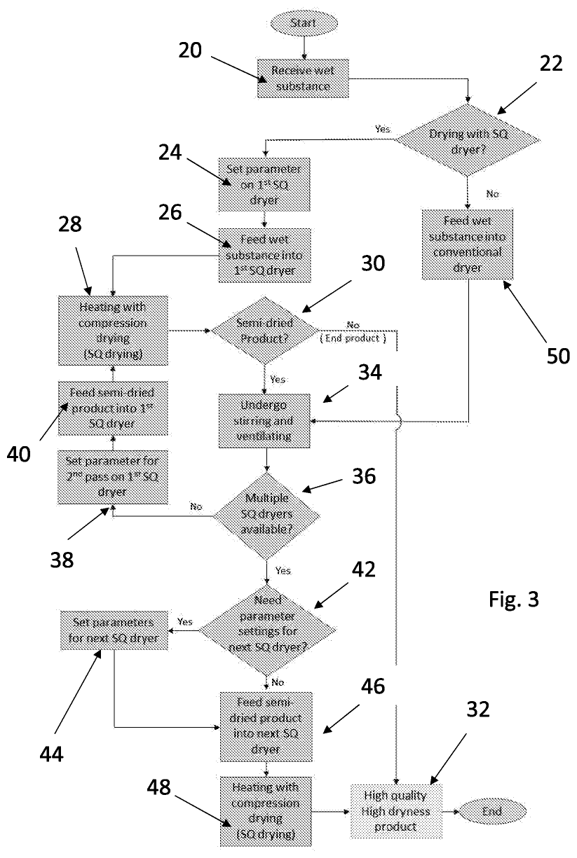

The multi-pass process flowchart shown in FIG. 3 further illustrates the various stages in a single-pass and multi-pass operations as described above. Following receipt of the wet substance (20), it is first decided whether an SQ dryer is being used for the first drying pass (22). If an SQ dryer is being used for the first pass, then the parameters are set on that SQ dryer (24) for the wet substance being dried. The wet substance is then fed into the first SQ dryer (26), so that the substance is subjected to heating with compression within that first SQ dryer (28). If the output from the first SQ dryer is a semi-dried product (30), then this semi-dried product must undergo further processing. If the output from the first SQ dryer requires no further processing, then this will be a single-pass operation, with the output from the SQ dryer being the end product (32). If the output from the first SQ dryer is a semi-dried product (30), then a two-pass operation is required where the semi-dried product must undergo a stirring and ventilating stage (34). If multiple SQ dryers are available (36), then it is first determined whether the parameters need to be set within the next SQ dryer (42) for the semi-dried product being processed. The parameters can be set on the next SQ dryer if required (44), and the semi-dried product fed into the next SQ dryer (46), where that product is subjected to heating with compression within the next SQ dryer (48). The output of the next SQ dryer is then the end product (32).

If only one SQ dryer is being used, then the parameters may need to be reset as required for a second pass within the first dryer (38), before the semi-dried product is fed though the first SQ dryer again (40) and subjected to heating and compression within the first SQ dryer (28). If the output from the first SQ dryer is still a semi-dried product (30), then that product can undergo a further pass through the first or next dryer (28), (48) until the output is the final high dryness product (32). If a conventional dryer is instead being used for the first pass, the wet substance will be first fed into that conventional dryer (50). The output from the conventional dryer is then subjected to stirring and ventilating (34) before being fed into an SQ dryer (40), (46) and subjected to heating and compression within that SQ dryer (28), (48). That process is repeated until the output of the final SQ dryer is the final high dryness end product (32).

The invention will be applicable where end products require high nutritional contents, high dryness and high throughput, such as for the production of:

### Functional Foods, Food Premix, Food Ingredients

Plant based food processing plants producing side streams such as barley spent grains, Okara (soy pulp) from soy processing plants, fruit pomace (grape, carrot, apple), etc., contains specific nutrition within the waste material. With the multi-pass drying process, we will be able to retain a large proportion of the desirable nutrients in highly dried form and be used as high value food premix or food ingredients.

Dried food production plants looking to dry wet food into dry food products for human consumption will be able to produce dried food products high in organoleptic and nutritional content due to the high throughput multi-pass drying process. Examples include traditional Chinese medication production plants or flour mills.

Other food processing operations such as meat, poultry or seafood processing plants produce large amounts of organic side streams that are rich in nutrients. The invention will convert these side streams into products containing high levels of protein and minerals to result in high quality food additives or ingredients.

### Animal/Aqua Feed

Fish processing facilities can look to convert fish waste into wholesome, aromatic and nutritious components of feed for various animals or aquatic animals to boost nourishment and taste.

The aquaculture industry in fish/shrimp feed production has been gradually moving away from wild feed for some time and have identified the need to manufacture fish feed with high nutrition while raising productivity, strengthen climate resilience and overcome resource constraints.

Therefore, the invention will be able to achieve high throughput to produce dried products of high dryness and quality which can last long shelf life to meet industrial demands.

Unless defined otherwise, all technical and scientific terms used herein have the same meaning as is commonly understood by a skilled person to which the subject matter herein belongs.

It should be appreciated by the person skilled in the art that the above invention is not limited to the embodiment described. It is appreciable that modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A multi-pass drying process for a wet substance comprising:
a) passing the wet substance through at least two different drying stages to produce a semi-dried product between the drying stages, and
b) stirring and ventilating the semi-dried product between each drying stage;
wherein the wet substance or the semi-dried product is subjected to compression while being heated in at least one of the drying stages.

2. The multi-pass drying process for a wet substance according to claim 1, wherein at least one of the drying stages is conducted within a drying assembly comprising at least one rotating drum, and at least one belt for supporting and compressing the wet substance or the semi-dried product as the or each belt travels around an external surface of the or each drum.

3. The multi-pass drying process for a wet substance according to claim 2, wherein the exterior surface of the or each rotating drum is heated by a heated fluid contained within the drum.

4. The multi-pass drying process for a wet substance according to claim 2, wherein the or each belt is formed from a metal material, and is heated using heat induction within the drying apparatus.

5. The multi-pass drying process for a wet substance according to claim 4, wherein the drum is made of metal when a single said belt is used.

6. The multi-pass drying process for a wet substance according to claim 4, wherein two said belts are provided, the wet substance or the semi-dried product being sandwiched between the belts.

7. The multi-pass drying process for a wet substance according to claim 1, wherein at least one of the drying stages is conducted by a conventional drying apparatus subjecting the wet substance to heat without compression.

8. The multi-pass drying process for a wet substance according to claim 7, wherein the conventional drying apparatus provides the first drying stage.

9. The multi-pass drying process for a wet substance according to any claim 1, wherein each of the drying stages subject the wet substance or the semi-dried product to compression while being heated.

10. The multi-pass drying process for a wet substance according to claim 1, wherein the stirring and ventilation of the semi-dried product between each drying stage is achieved naturally during the handling of the semi-dried product while being transferred between each drying stage.

11. The multi-pass drying process for a wet substance according to claim 1, wherein the stirring and ventilation of the semi-dried product between each drying stage is achieved using an assistive device for performing a stirring and ventilating action on the semi-dried product.
